(19) United States
(12) Patent Application Publication
(10) Pub. No.: US 2007/0047711 A1
(43) Pub. Date: Mar. 1, 2007

(54) Personalized on-hold music

(76) Inventors: Cynthia Florkey, Chicago, IL (US); Ruth Schaefer Gayde, Naperville, IL (US); John Richard Rosenberg, Elmhurst, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/216,871

(22) Filed: Aug. 31, 2005

(51) Int. Cl. H04M 1/00

(52) U.S. Cl. 379/162

(57) ABSTRACT

The present invention provides a method for providing personalized on-hold music to a user. When a user is placed on hold, a determination is made as to whether the user subscribes to a personalized music on-hold service. If the user subscribes to the personalized music on-hold service, personalized on-hold music is sent to the user during the time that the user is on hold.

### FIELD OF THE INVENTION

The present invention relates generally to communication systems, and more particularly to music or other audio played to a phone that is placed on hold.

### BACKGROUND OF THE INVENTION

In current communication systems, users are occasionally placed on hold. In order to make the time spent on hold more interesting, on hold music or other audio has been employed. Typically, a company that has on-hold music either plays the same music to all callers placed on hold, or plays an announcement that gives information, typically relating to the called company, to the on-hold caller. In either case, identical predetermined audio is played to all callers who are placed on hold.

Businesses often lose callers who drop off the line after being placed on hold. These lost calls can translate into lost business.

Therefore, a need exists for a method and system that allows companies to play interesting music or audio to users that are on hold.

### BRIEF SUMMARY OF THE INVENTION

The present invention provides a method for providing personalized on-hold music to a user. A user will be able to pre-select music to be played whenever the user is placed on hold. Any source of music or other audio can be provided to an on-hold user.

In accordance with an exemplary embodiment, the communication network is able to optimally convert from the music source's native format to the appropriate format for the user device, such as an analog phone, a CDMA phone, G.711 for IP, etc.

An exemplary embodiment comprises the service and the underlying technology to allow the service provider's network to determine when a subscriber's call has been put on hold, connect the subscriber to his pre-selected music source, converting the music format as appropriate, and then recognizing that the call has gone off hold and reconnecting the subscriber to the original other party.

In a further exemplary embodiment, pre-selected music can be provided by call centers. The call center may provide music from its own music server, or it may use a network-based music server that can be used by many call centers.

Further, a conference bridge can provide music which will be played to all parties on the conference bridge while they wait for the moderator to join. The music can be preselected by the moderator, or can be tailored such that each user receives personalized music specifically in line with each user's preferences.

Subscribers may pay money to be able to choose the music they have to listen to on hold. Additionally, call centers may enjoy the benefit of less-irritated callers when waits are long, and may be willing to pay a premium for a service such as that provided by the present invention.

### BRIEF DESCRIPTION OF THE SEVERAL VIEWS OF THE DRAWINGS

FIG. 1 depicts a communication system for providing personalized on-hold music in accordance with an exemplary embodiment of the present invention.

FIG. 2 depicts a call flow diagram for providing personalized on-hold music by the caller's network service provider in accordance with an exemplary embodiment of the present invention.

FIG. 3 depicts a call flow diagram for providing personalized on-hold music in response to a request in accordance with an exemplary embodiment of the present invention.

FIG. 4 depicts a call flow diagram for providing personalized on-hold music for members of a subscriber group in accordance with an exemplary embodiment of the present invention.

FIG. 5 depicts a call flow diagram for providing personalized on-hold music for members of a conference call prior to a moderator joining the conference call in accordance with an exemplary embodiment of the present invention.

### DETAILED DESCRIPTION OF THE INVENTION

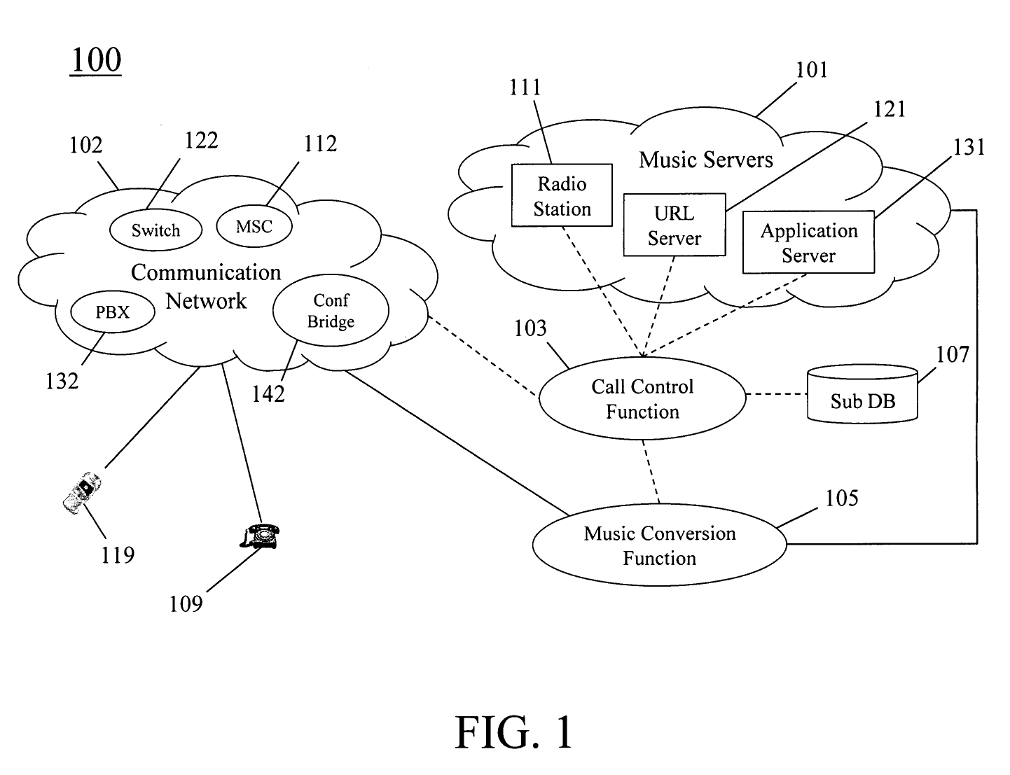

FIG. 1 depicts a communication system 100 for providing personalized on-hold music in accordance with an exemplary embodiment of the present invention. Communication system 100 includes music server 101, communication network 102, call control function (CCF) 103, music conversion function 105, and subscriber database 107.

Music server 101 includes a plurality of servers that provide music or other audio for callers on hold. In this exemplary embodiment, music server 101 comprises radio station server 111, URL server 121, and application server 131. Radio station server 111 includes audio streams of radio stations. URL server 121 includes links to websites that include streaming audio that can be routed to a caller placed on hold. Application server 131 includes processing and data that can be used to provide audio to a user. Application server 131 may include a database of digitized audio, such as MP3 or .WAV files, that can be sent to a user on hold.

Communication network 102 is a network that provides access to communication lines for placing and receiving calls. Communication network 102 can provide wireless service to users utilizing Mobile Switching Center (MSC) 112, wireline service to users utilizing switch 122, business applications using Private Branch Exchange (PBX) 132, or conference calling capability using conference bridge 142. Communication network 102 includes necessary elements to provide support for calls.

CCF 103 is network intelligence that provides call processing and control. CCF 103 performs the setting up, monitoring, control and tearing down of calls. The call control function can be a separate element as depicted in FIG. 1, but the functionality of the CCF can alternately be included within elements within communication network 102.

MSC 112 is a switch, similar to a central office switch, that bridges a mobile telephone network with another telephone network such as a PSTN. MSC 112 is a sophisticated telephone exchange that provides circuit-switched calling, mobility management and services to mobile phones roaming within the area that it serves.

Music conversion function 105 receives an audio stream from CCF 103 and converts the audio stream into a format that the on-hold caller can receive. In an exemplary embodiment, music conversion function 105 receives digital audio. The digital audio can be compressed, which allows a storage medium to store more audio. The compressed audio needs to be decompressed and converted into a form that the receiving device can effectively process. Music conversion function 105 provides this conversion from a format that a unit cannot translate into a format that is readily accessible by a receiving unit.

Subscriber database 107 is coupled to CCF 103 and includes information about subscribers to the personalized on-hold music service. Subscribers can be individuals or groups.

Users 109 and 119 are preferably communication units that allow communication with communication network 102. Users 109 and 119 can be wireline or wireless units, or any communication units that are able to send and receive audio signals to a communication network. In FIG. 1, user 109 is depicted as a wireline user, and user 119 is depicted as a wireless user, although this configuration is not required. User 109 and user 119 do not have to be utilizing the same protocol or be the same type of phone.

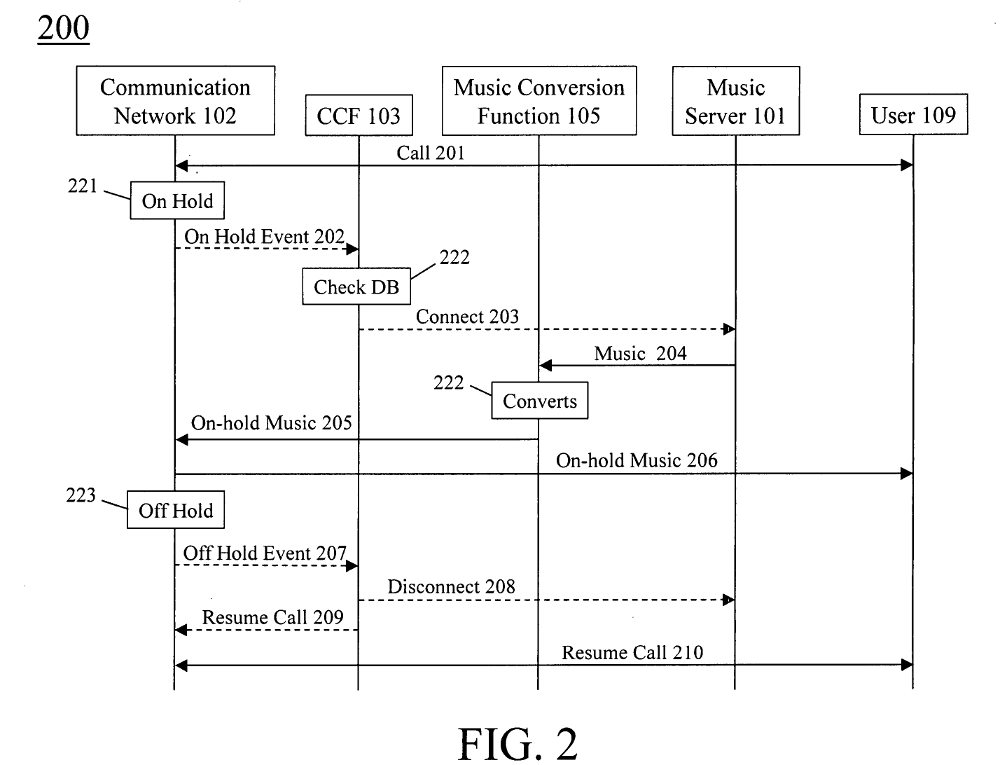

FIG. 2 depicts a call flow diagram 200 for providing personalized on-hold music by the caller's network service provider in accordance with an exemplary embodiment of the present invention. In this exemplary embodiment, the personalized on-hold music is provided in the network by the caller's network service provider. In this exemplary embodiment, the subscriber arranges with the service provider for the personalized music on-hold service by subscribing to the personalized music on-hold service. Subscription preferably includes service provider provisioning in a subscriber database, such as an HLR, HSS, SCP, or local database.

Subscription information for a subscriber preferably includes a pointer to a playlist. The playlist may include content by genre, maintained in the service provider network, such as 70s Hits, Beethoven, or Broadway Tunes. Alternately, the playlist may include content accessed by a specific URL, such as a internet streaming audio or content from a personalized playlist specified by the subscriber. Still further, the playlist can include content from a “Music of the Day” selection.

In an exemplary embodiment, the playlist can be assembled by selecting songs made available by the service provider, or from songs uploaded to the service provider's network by the subscriber. This could be done using a web interface via a different device such as a PC or in any other appropriate manner.

In accordance with this exemplary embodiment, a call 201 is in progress. In this exemplary embodiment, unit 119 and unit 109 are engaged in call 201. Unit 119 puts unit 109 on hold. In an alternate exemplary embodiment, unit 109 is put on hold prior to connecting with unit 119, such as when unit 109 calls unit 119 while unit 119 is involved in another call.

Switch 122 detects (221) that unit 109 is on hold. In an exemplary embodiment, switch 122 detects that unit 109 is on hold by detecting silence or utilizing speech recognition. In a further exemplary embodiment, switch 122 detects that unit 109 is on hold by receiving a signaling message, such as an ISUP CPG: Call ProGress message. In an alternate exemplary embodiment, unit 109 can indicate that it has been placed on hold by dialing or pressing a flash or feature code.

Switch 122 determines that unit 109 subscribes to the personalized music on-hold service by sending on hold event control message 202 to Call Control Function 103.

CCF 103 checks (222) subscriber database 107 to determine if unit 109 has subscribed to the personalized on-hold music service.

If unit 109 subscribed to the personalized on-hold music service, CCF 103 sends connect message 203 to Music Server 101.

Music Server 101 determines the type of on-hold music requested and sends music 204 to Music Conversion Function 105. Communication system 100 determines whether music 204 needs to be converted in order to be properly received and listened to by unit 109. In an exemplary embodiment, communication system 100 determines the proper format for conversion based on the type of bearer that is needed by the network to communicate with user 109. If music 204 needs to be converted, music conversion function 105 converts (223) music 204 into a suitable format.

Music Conversion Function 105 sends on-hold music 205 to communication network 102. In the embodiment depicted in FIG. 2, the on-hold music is sent to switch 122. Switch 122 sends on-hold music 206 to user 109. Stream 206 preferably continues until user 119 returns to the call.

Communication network 102 determines at some point while unit 109 is on hold that unit 119 has returned to the call. In an exemplary embodiment, communication network 102 makes this determination upon receiving voice from unit 119. At this point, communication network 102 knows that unit 119 has returned to the call. Communication network 102 sends off hold event 207 to CCF 103.

CCF 103 sends disconnect control message 208 to Music Server 101. In response to disconnect control message 208, Music Server 101 discontinues music stream 204. CCF 103 releases Music Conversion Function 105.

CCF 103 sends resume call message 209 to communication network 102. Communication network 102 sends resume call message 210 to user 109 and the active call is reestablished between user 109 and user 119.

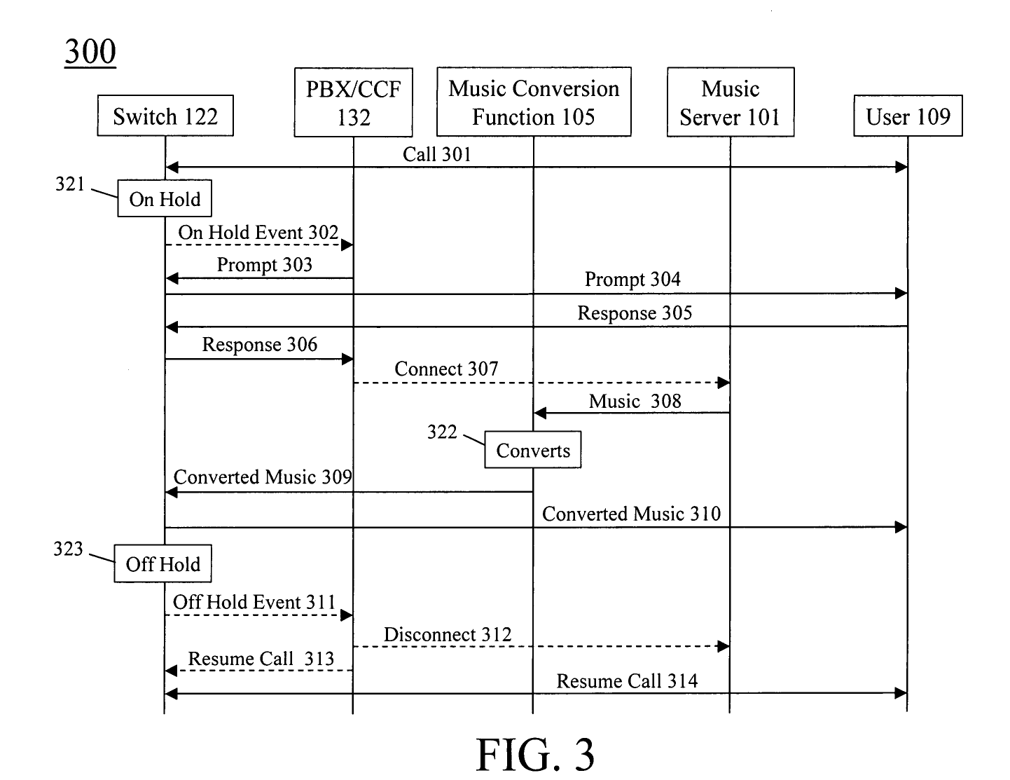

FIG. 3 depicts a call flow diagram 300 for providing personalized on-hold music in response to a request in accordance with an exemplary embodiment of the present invention. In this exemplary embodiment, a call center prompts the caller who has been placed on hold for what type of music they want to listen to. In this embodiment, the call control function is depicted as part of PBX 132.

In accordance with this exemplary embodiment, a call 301 is in progress between unit 119 and unit 109. In this exemplary embodiment, unit 119 and unit 109 are engaged in call 301 and unit 119 puts unit 109 on hold. In an alternate exemplary embodiment, unit 109 is put on hold prior to connecting with unit 119, such as when unit 109 calls unit 119 while unit 119 is involved in another call.

Switch 122 detects (321) that unit 109 is on hold. In an exemplary embodiment, switch 122 detects that unit 109 is on hold by detecting silence or utilizing speech recognition. In a further exemplary embodiment, switch 122 detects that unit 109 is on hold by receiving a signaling message. In an alternate exemplary embodiment, unit 109 can indicate that it has been placed on hold by dialing or pressing a flash or feature code.

In response to the determination at step 321 that unit 109 is on hold, switch 122 sends on hold event message 302 to PBX/CCF 132. On hold event message 302 preferably includes an indication that user 109 has been placed on hold and an indication that PBX/CCF 132 should proceed to determine the type of on-hold music or audio that user 109 desires.

PBX/CCF 132 sends prompt message 303 to switch 122. Switch 122 sends prompt message 304 to user 109. Prompt messages 303 and 304 can include, for example, a prompt such as “Press 1 for 70's Hits, 2 for Classical Music” and so forth.

User 109 keys or speaks a selection on their phone, and response 305 is sent from user 109 to switch 122. Response 305 includes the user selection of the type of music that user 109 would like to listen to while on hold.

Switch 122 processes response 305 and, if valid, sends response message 306 to PBX/CCF 132. Response message 306 preferably includes the selection made by user 109.

PBX/CCF 132 sends connect message 307 to music server 101. Connect message 307 preferably includes the type of music selected by user 109. If the selection by user 109 is not a valid selection, PBX/CCF 132 preferably re-sends prompt message 304 in an attempt to obtain a valid selection from user 109.

Music Server 101 retrieves the appropriate type of music, preferably by keying off the selection included in connect message 307, and sends music 308 to Music Conversion Function 105.

Communication system 100 determines whether music 308 needs to be converted in order to be properly received and listened to by unit 109. If so, music conversion function 105 converts (322) music 308 into a suitable format.

Music Conversion Function 105 sends converted on-hold music 309 to switch 122. Switch 122 sends converted music 310 to user 109. In accordance with an exemplary embodiment, on-hold music 310 is sent for the duration of the on-hold session.

Switch 122 determines (323) at some point while unit 109 is on hold that unit 119 has returned to the call. In an exemplary embodiment, switch 122 detects that unit 109 is on hold by detecting silence or utilizing speech recognition. In a further exemplary embodiment, switch 122 detects that unit 109 is on hold by receiving a signaling message. In an alternate exemplary embodiment, unit 109 can indicate that it has been placed on hold by dialing or pressing a flash or feature code.

Switch 122 sends off hold event 311 to PBX/CCF 132. PBX/CCF 132 sends disconnect control message 312 to Music Server 101. In response to disconnect control message 312, Music Server 101 discontinues music stream 308. PBX/CCF 132 sends resume call message 313 to switch 122, and releases Music Conversion Function 105. The call between user 109 and user 119 is thereby re-established.

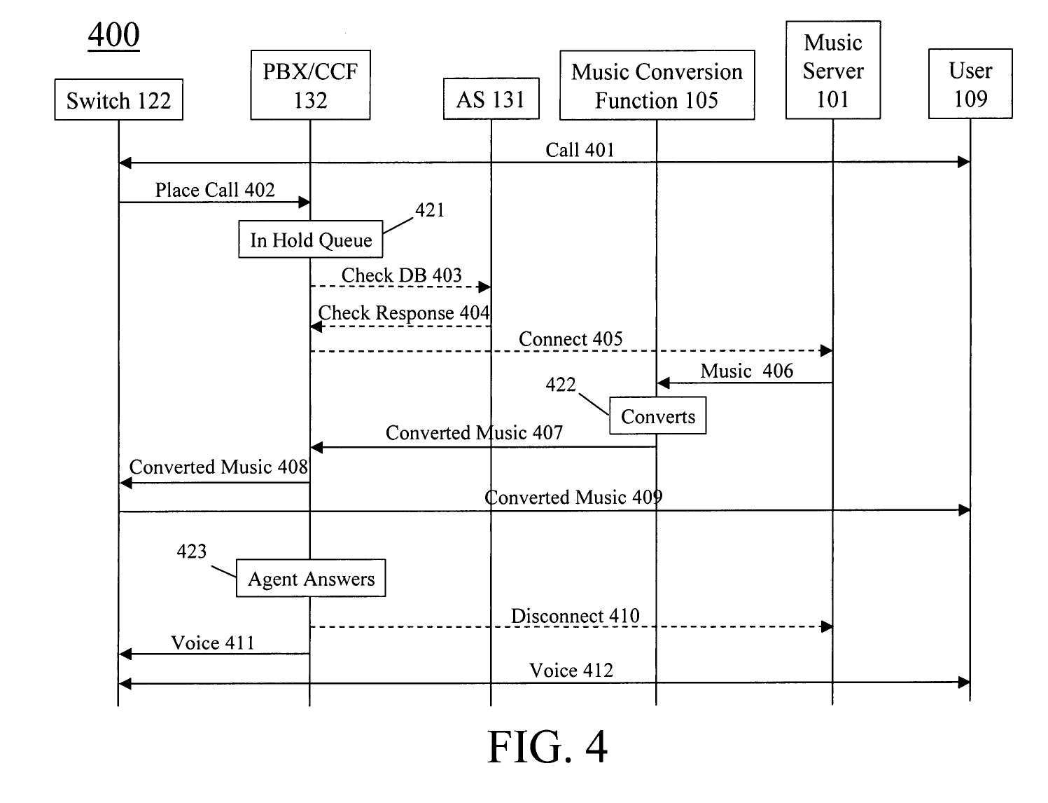

FIG. 4 depicts a call flow diagram 400 for providing personalized on-hold music for members of a subscriber group in accordance with an exemplary embodiment of the present invention. In this exemplary embodiment, a call center belongs to a group that provides members with personalized hold music. As an example, corporations that utilize call centers can belong to the group. In addition, individuals can subscribe to the group.

User 109 calls a business, such as an airline customer service center, by placing a call 401 with switch 122. Switch 122 sends place call message 402 to PBX/CCF 132. In this exemplary embodiment, there are currently no call agents available, so user 109 is placed (421) into a hold queue.

PBX/CCF 132 determines what to play to caller 109 while user 109 is on hold. PBX/CCF 132 sends check database message 403 to application server 131 to determine if user 109 is a subscriber to an on-hold personalized music group. Check database message 403 preferably includes a calling party identifier, such as the directory number of user 109 or the Public User Identity for user 109. Alternately, the calling party identifier comprises a customer number associated with the caller. For example, the calling party identifier can be the frequent flyer number of the caller. Application server 131 preferably resides on a Service Control Point (SCP) or Application Server (AS).

Application server 131 checks to see if user 109 is a subscriber to the on-hold personalized group, preferably by comparing the calling party identifier against a list of subscriber identifiers. Application server 131 sends check response 404 to PBX/CCF 132. In an exemplary embodiment, check response 404 includes a flag indicating whether the user is a subscriber to the service and a music server identification for the subscriber. In the embodiment depicted in FIG. 4, user 109 is a subscriber to the on-hold personalized group. If user 109 is not a subscriber to the personalized on-hold music group, PBX/CCF 132 can select the type of audio for the user 109 to hear while on hold. In an alternate exemplary embodiment, the communication system can prompt the caller who has been placed on hold for what type of music they want to listen to.

PBX/CCF 132 sends connect message 405 to music server 101. Music server 101 determines the music choice for the subscriber by retrieving a record associated with the received subscriber identification, such as the CPN (Calling Party Number) or Public User Identity.

Music server 101 sends music 406 to music conversion function 105. Music 406 is preferably music, but can alternately be audio such as a radio program, a “book on tape”, a commercial, or the like.

Music conversion function 105 converts (422) the music received from music server 101. This bearer conversion of the music source format converts music 406 to the format predetermined by PBX/CCF 132. Music conversion function 105 sends converted music 407 to PBX/CCF 132.

PBX/CCF 132 sends converted music 408 to switch 122. Switch 122 sends converted music 409 to user 109. Music 409 preferably continues for the length of time that user 109 is on hold.

At some point, PBX/CCF 132 determines (423) that a call center agent has answered the call from user 109. In an exemplary embodiment, PBX/CCF 132 detects that a call center representative has answered the call by detecting voice or other noise on the line. In a further exemplary embodiment, PBX/CCF 132 detects that a call center representative has answered the call by receiving a signaling message.

After detecting that a service representative has joined the call and removed user 109 from being on hold, PBX/CCF 132 sends disconnect message 410 to music server 101. This starts the tearing down of the connection with music server 101 and releases music conversion function 105. In response to disconnect message 410, music server 101 stops music stream 406.

PBX/CCF 132 sends voice 411 to switch 122, and switch 122 sends voice 412 to user 109 and user 119. In this manner, the call is begun using the bearer path between user 109 and a call center representative.

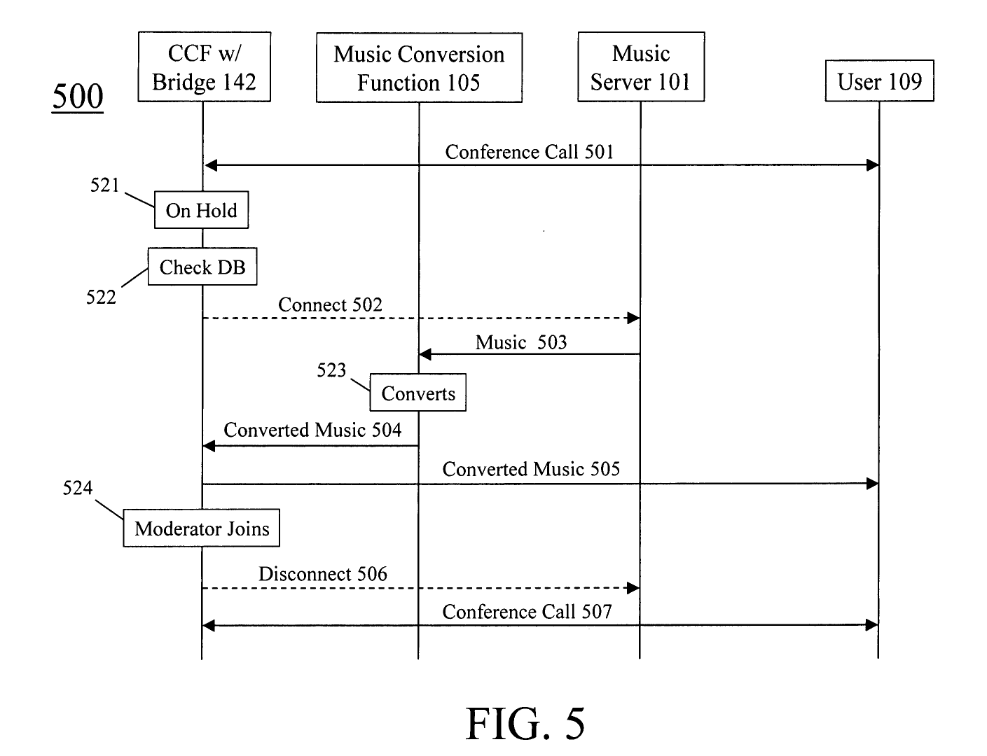

FIG. 5 depicts a call flow diagram 500 for providing personalized on-hold music for members of a conference call prior to a moderator joining the conference call in accordance with an exemplary embodiment of the present invention. In this exemplary embodiment, a conference bridge is used and a moderator of the conference call must be present on the conference bridge before all parties can begin talking. The moderator pre-selects the choice of music to be played on hold to the parties who join before the moderator joins. In this embodiment, the moderator's subscription to the personalized on-hold music is used to play the moderator's choice of music to all other parties that join the conference call prior to the moderator.

Prior to a conference call, a moderator reserves a conference bridge. The dial in number for the conference call are communicated to a plurality of users that are intended for the conference call. Conference calls typically also include a conference code for the conference call. In a typical conference call, a plurality of users dial in to the conference call. In the embodiment depicted in FIG. 5, only one user, user 109, is depicted for clarity. User 109 places a call 501 to a conference bridge.

In the exemplary embodiment depicted in FIG. 5, the moderator has not yet joined the conference call, so user 109 is initially placed (521) on hold.

CCF w/Bridge 142 checks (522) a database to determine what should be played to user 109 while on hold. In an exemplary embodiment, CCF w/Bridge 142 sends connect message 502 to Music server 101. Connect message 502 preferably includes the identity of the moderator so that music server 101 can use the identity to determine the music or other audio to play to the conference code attendees who are placed on hold prior to the start of the conference call. In an alternate exemplary embodiment, connect message 502 includes an identifier of user 109. In this embodiment, music server 101 selects music or other audio that is appropriate for user 109. This can occur if user 109 subscribes to a personalized on-hold music service, for example. In this embodiment, each user who calls the conference bridge prior to the moderator joining would hear music or other audio tailored to each user's own preferences.

Music server 101 sends music 503 to music conversion function 105. Music server 101 provides music stream 503 to music conversion function 105, which converts (523) audio stream 503 according to whatever bearer CCF w/Bridge 142 supports and sends converted music 504 to CCF w/bridge 142. CCF w/bridge 142 forwards converted music 505 to user 109. User 109 listens to music 505 until the moderator joins the conference call.

At some point, the moderator joins (524) the conference call. CCF w/Bridge 142 recognizes the moderator, preferably by the conference code that the moderator dialed in.

CCF w/Bridge 142 is now ready to begin the conference call, and so sends disconnect message 506 to music server 101. In an exemplary embodiment, disconnect message 506 includes the identity of the moderator. In this manner, music server 101 is able to identify which music stream should be stopped. The conference call 506 then begins.

While this invention has been described in terms of certain examples thereof, it is not intended that it be limited to the above description, but rather only to the extent set forth in the claims that follow.

1. A method for providing personalized on-hold music to a user, the method comprising:
determining that a user is placed on hold;
determining whether the user subscribes to a personalized music on-hold service; and
if the user subscribes to the personalized music on-hold service, sending personalized on-hold music to the user.

2. A method for providing personalized on-hold music in accordance with claim 1, wherein the step of determining that a user is placed on hold comprises receiving a feature code from the user.

3. A method for providing personalized on-hold music in accordance with claim 1, wherein the step of determining that a user is placed on hold comprises utilizing silence detection.

4. A method for providing personalized on-hold music in accordance with claim 1, wherein the step of determining that a user is placed on hold comprises receiving a predetermined signaling message.

5. A method for providing personalized on-hold music in accordance with claim 1, wherein the step of determining whether the user subscribes to a personalized music on-hold service comprises checking a subscriber database.

6. A method for providing personalized on-hold music in accordance with claim 1, the method further comprising the step of converting the personalized on-hold music.

7. A method for providing personalized on-hold music in accordance with claim 1, the method further comprising the step of discontinuing the personalized on-hold music when the user is no longer on hold.

8. A method for providing personalized on-hold music in accordance with claim 1, wherein step of determining whether the user subscribes to a personalized music on-hold service comprises comparing a calling party identifier of the user with a list of subscriber identifiers in a personalized on-hold music database.

9. A method for providing personalized on-hold music in accordance with claim 1, wherein step of determining whether the user subscribes to a personalized music on-hold service comprises checking a flag in a message sent to a call control function.

10. A method for providing personalized on-hold music in accordance with claim 1, the method further comprising the step of, if the user does not subscribe to the personalized music on-hold service, prompting the user for a selection of a preferred music type.

11. A method for providing personalized on-hold music in response to a request by a user placed on hold, the method comprising:
determining that a user has been placed on hold;
querying the user regarding the music selection preference of the user;
receiving a selection made by the user, the selection indicating the music selection preference of the user; and
sending on-hold audio to the user.

12. A method for providing personalized on-hold music in response to a request by a user placed on hold in accordance with claim 11, the method further comprising the step of utilizing the selection made by the user to select the on-hold audio.

13. A method for providing personalized on-hold music in response to a request by a user placed on hold in accordance with claim 11, the method further comprising the step of discontinuing the on-hold audio to the user when the user is no longer on hold.

14. A method for providing personalized on-hold music for callers on a conference call prior to a moderator joining the conference call, the method comprising:
receiving a valid conference call request from a user;
placing the user on hold;
determining on-hold music to play to the user; and
playing the on-hold music for the user.

15. A method for providing personalized on-hold music for callers on a conference call prior to a moderator joining the conference call in accordance with claim 14, wherein the step of determining the on-hold music to play to the user comprises determining the on-hold music to play to the user based upon an identifier associated with the moderator.

16. A method for providing personalized on-hold music for callers on a conference call prior to a moderator joining the conference call in accordance with claim 15, wherein the step of determining the on-hold music to play to the user based upon an identifier associated with the moderator comprises checking an on-hold music database.

17. A method for providing personalized on-hold music for callers on a conference call prior to a moderator joining the conference call in accordance with claim 14, wherein the step of determining the on-hold music to play to the user comprises determining the on-hold music to play to the user based upon an identifier associated with the user.

18. A method for providing personalized on-hold music for callers on a conference call prior to a moderator joining the conference call in accordance with claim 14, the method further comprising the step of discontinuing the on-hold music to the user when the moderator joins the conference call.

19. A method for providing personalized on-hold music for callers on a conference call prior to a moderator joining the conference call in accordance with claim 18, wherein the step of discontinuing the on-hold music to the user when the moderator joins the conference call comprises sending a disconnect message including an identifier of the moderator.

20. A method for providing personalized on-hold music for callers on a conference call prior to a moderator joining the conference call in accordance with claim 14, wherein the step of playing the on-hold music for the user comprises converting the on-hold music.
